(19) United States
(12) Patent Application Publication
(10) Pub. No.: US 2023/0166484 A1
(43) Pub. Date: Jun. 1, 2023

(54) HEAT-INSULATING MULTI-LAYER MATTRESS

(71) Applicant: AIRBUS DEFENCE AND SPACE SAS, Toulouse Cedex 4 (FR)

(72) Inventors: Fabrice MENA, Toulouse Cedex 4 (FR); Eric BEAUFUMÉ, Toulouse Cedex 4 (FR); Arthur VAN DEN BERG, Toulouse Cedex 4 (FR); Philippe CLAVIÈRES, Toulouse Cedex 4 (FR); Marion SODE, Toulouse Cedex 4 (FR)

(21) Appl. No.: 17/920,773

(22) PCT Filed: Apr. 23, 2021
(86) PCT No.: PCT/FR2021/050706

§ 371 Date: Oct. 21, 2022

(30) Foreign Application Priority Data
Apr. 23, 2020 (FR) 20 04064

(51) Int. Cl. B32B 27/08; B32B 27/28; B32B 27/32

(52) U.S. Cl. CPC B32B 27/08; B32B 27/281; B32B 27/322; B32B 2250/05; B32B 2250/24; B32B 2255/10; B32B 2307/304; B32B 2571/00; B32B 2605/18

(57) ABSTRACT

A heat-insulating multi-layer blanket for a spacecraft is disclosed including a stack of numerous heat-insulating layers, and an external layer superimposed on the stack. The external layer includes a second surface mirror (SSM) film, including a mirror layer placed under a fluorinated ethylene propylene (FEP) layer, and a polyimide layer joined to the SSM film. The blanket has two different configurations depending on the side of the external layer that is exposed to space.

### TECHNICAL FIELD

This application concerns a heat-insulating multi-layer blanket for spacecraft, also called MLI for “Multi Layer Insulation”, and a method for the thermal protection of a spacecraft using such a blanket.

### PRIOR ART

MLI-type multi-layer blankets are conventionally used to provide thermal insulation for certain parts of spacecraft such as a satellite or a space probe. These blankets are attached to the external walls to be protected, interposed between the spacecraft and space and thus blocking incident radiation.

To provide thermal insulation, the blankets conventionally used comprise a stack of heat-insulating layers, for example formed from polyimide or Kapton (trade name).

In addition, these blankets comprise an external layer having a composition generally adapted to usage constraints during operation of the spacecraft, and in particular to constraints linked to the altitude at which it operates.

For spacecraft such as satellites intended to operate in low Earth orbit, also referred to by the acronym LEO, which corresponds to altitudes of the order of 450 km to 2000 km in altitude, the main function of the external layer of a multi-layer blanket is to protect the stack of heat-insulating layers of the blanket against atomic oxygen, which is highly corrosive.

For this purpose, it is known to use an external layer formed from a material called Beta cloth, which is a fiberglass fabric coated with polytetrafluoroethylene (PTFE), a compound better known by its trade name of Teflon.

Beta cloth fulfills the role of protecting against atomic oxygen, while the stack of heat-insulating layers arranged under the external layer provides thermal protection.

However, this blanket structure using Beta cloth is not without shortcomings. In particular, it is very expensive because the Beta cloth itself is expensive, and moreover is difficult to manipulate in order to use it to cover a satellite. Indeed, Beta cloth is relatively rigid, which during handling sometimes causes cracks to appear thus rendering the blanket ineffective and irreparable; it must then be replaced.

In addition, a blanket equipped with an external layer of Beta cloth must be sewn manually in order to prevent the formation of gaps, since the presence of Teflon prevents the traditional use of adhesive tape to secure adjacent pieces of blanket together. This manual sewing further increases the cost of manufacturing and installing the blanket, but also the risk of damage from handling.

In addition, Beta cloth has a high absorptivity of around 50%, which causes it to heat to a temperature of around 80° C. when exposed to the sun. This can be a disadvantage for the rest of the spacecraft and in particular for adjacent surfaces of the spacecraft which can receive increased infrared radiation due to this heating.

### SUMMARY

The purpose of the invention is to overcome the disadvantages of the prior art.

In particular, one aim of the invention is to provide a thermal protection blanket for spacecraft which has good resistance to atomic oxygen while not having the disadvantages of the Beta cloth described above.

Another aim of the invention is to provide a thermal protection blanket which is less costly and simpler to install on a spacecraft wall.

Another aim of the invention is to provide a thermal protection blanket that heats up less when exposed to the sun.

In this respect, the invention proposes a heat-insulating multi-layer blanket for spacecraft, comprising:
a stack of a plurality of heat-insulating layers, and
an external layer superimposed on the stack, characterized in that the external layer comprises:
a second surface mirror (SSM) film, comprising a mirror layer placed under a fluorinated ethylene propylene (FEP) layer, and
a polyimide layer joined to the SSM film.

In some embodiments, the fluorinated ethylene propylene (FEP) layer has a thickness greater than 50 µm.

In some embodiments, the polyimide layer is adhered to the mirror layer on the side of the mirror layer that is opposite to the FEP layer.

In some embodiments, the external layer is arranged so that the polyimide layer is located on the side that is towards the stack of heat-insulating layers. Alternatively, the external layer may be arranged so that the second surface mirror (SSM) film is located on the side that is towards the stack of heat-insulating layers.

In some embodiments, the mirror layer is made of metal and the external layer comprises at least one area devoid of polyimide in order to allow grounding the mirror layer.

In some embodiments, the layers of the stack are formed of polyimide comprising a metal coating.

This application also relates to a spacecraft comprising thermal protection attached to its walls, characterized in that the thermal protection is formed from the heat-insulating blanket according to the above description.

In some embodiments, the thermal protection of the spacecraft is formed:
on at least one wall of the spacecraft: of blanket in which the external layer is arranged so that the polyimide layer is located on the side that is towards the stack of heat-insulating layers, and so that the second surface mirror (SSM) layer is the exposed surface of the blanket, and
on at least one other wall of the spacecraft: of blanket in which the external layer is arranged so that the second surface mirror (SSM) film is located on the side that is towards the stack of heat-insulating layers, and so that the Kapton layer is the exposed surface of the blanket.

The present application also relates to a method for the thermal protection of a spacecraft comprising a set of external walls to be covered with a heat-insulating blanket, the method comprising:
the determination, according to a geometry and an operational position anticipated for the spacecraft, of external walls of the spacecraft that should not produce specular reflection,
the covering of said external walls with a blanket in which the external layer is arranged so that the second surface mirror (SSM) film is located on the side that is towards the stack of heat-insulating layers, such that the Kapton layer is the exposed surface of the blanket for these walls, and
the covering of the other walls with a blanket in which the external layer is arranged so that the polyimide layer is located on the side that is towards the stack of heat-insulating layers, such that the second surface mirror (SSM) layer is the exposed surface of the blanket for these walls.

This application also relates to the use of a second surface mirror (SSM) film joined to a polyimide layer to create an external layer of a heat-insulating multi-layer blanket according to the above description.

The multi-layer blanket presented offers good protection against atomic oxygen due to the presence of fluorinated ethylene propylene (FEP) in the second surface mirror or SSM film present in the external layer. In addition, this SSM film, due to its UV-reflecting properties, heats up less in comparison to an external layer formed from Beta cloth or conventional Kapton.

In addition, the fact that the SSM film is supported by a Kapton layer has several advantages. On the one hand, the presence of a Kapton support layer facilitates installation of the blanket on a satellite wall since, unlike Beta cloth, sewing it is not required: this blanket can be installed using conventional techniques of riveting and adhering with double-sided adhesive, by folding the external layer to adhere the Kapton layer. The external layer is also easier to manipulate and causes less waste due to tears.

Furthermore, the structure of the external layer allows the use of two blanket configurations: in the first, the SSM film is the visible surface of the blanket, the Kapton layer being on the side towards the wall, and in this case it is possible to benefit from the thermal advantages provided by the properties of the SSM. In the second configuration, the external layer is flipped over so that the Kapton layer is exposed and the SSM film is towards the wall. In this case, the protection against atomic oxygen is still provided by the SSM film but the Kapton layer, less reflective than the SSM, is visible. This configuration is particularly suitable for spacecraft walls to be covered that should not generate produce specular reflection.

### BRIEF DESCRIPTION OF DRAWINGS

Other features, details, and advantages will become apparent upon reading the detailed description below, and upon analyzing the appended drawings, in which:

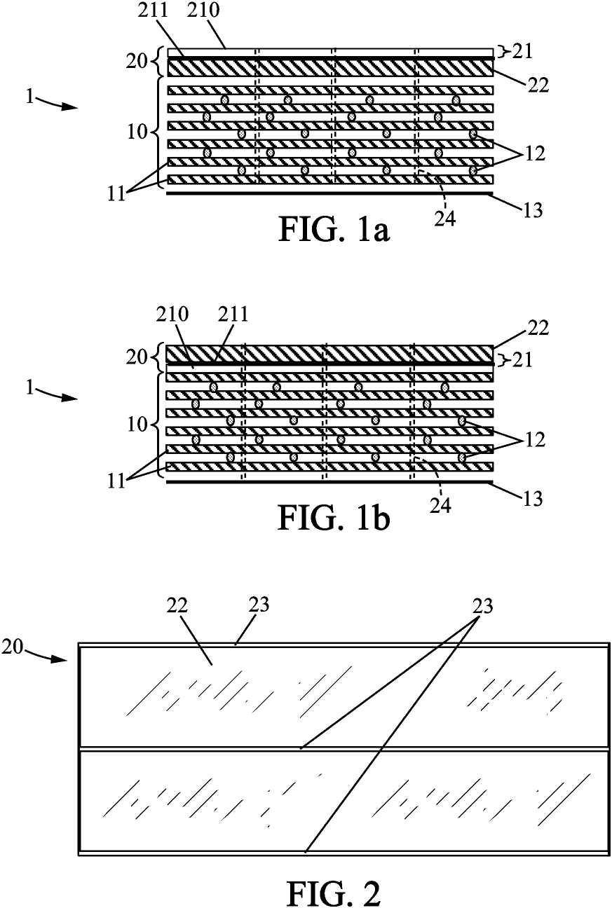

### FIG. 1a

[FIG. 1a] schematically represents a sectional view of a blanket according to one embodiment.

### FIG. 1b

[FIG. 1b] schematically represents a sectional view of a blanket according to another embodiment.

### FIG. 2

[FIG. 2] represents an external layer of a blanket according to one embodiment, viewed above the polyimide layer.

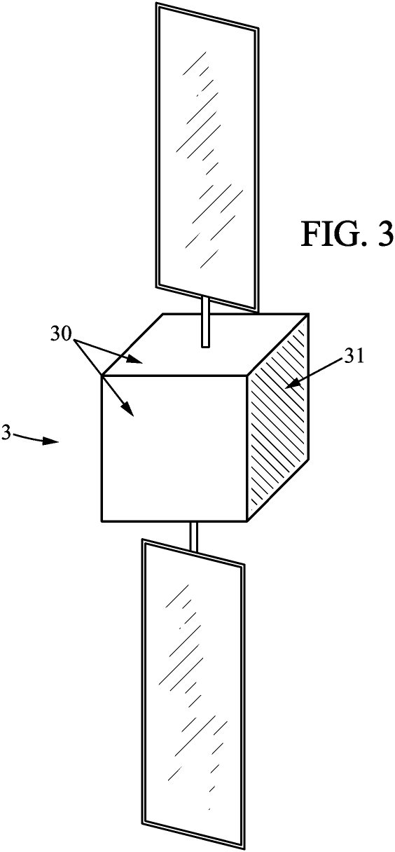

### FIG. 3

[FIG. 3] schematically represents a satellite covered with a thermal protection blanket according to one embodiment.

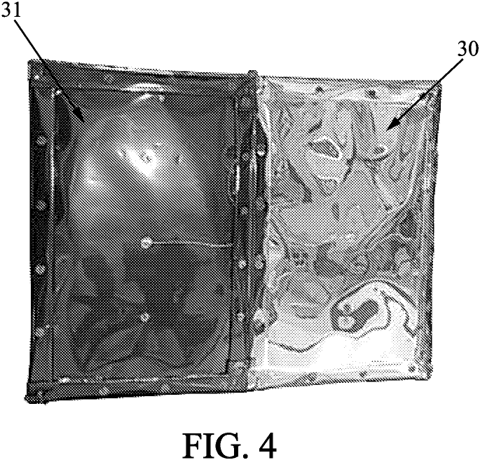

### FIG. 4

[FIG. 4] is a photo of a spacecraft wall respectively covered with a blanket according to two different embodiments.

### DESCRIPTION OF EMBODIMENTS

With reference to FIGS. 1a and 1b, we will now describe a heat-insulating multi-layer blanket 1 or MLI for spacecraft, for example a satellite or space probe, and in particular a blanket suitable for the thermal protection of spacecraft in low Earth orbit or LEO. In the following, the term “space” designates the part of the universe located outside any spacecraft, and in particular outside a spacecraft equipped with the blanket 1 and in low Earth orbit. The term “external” refers to the layer or surface of a blanket exposed to space when the blanket is installed on a spacecraft.

The blanket 1 comprises a stack 10 of heat-insulating layers 11 superimposed on each other, comprising between 5 and 30 superimposed sheets 11. Each layer 11 may be formed, for example, of polyimide or Kapton (trade name used below), of a thickness that may be between 10 and 50 µm, optionally covered by a metal coating (not shown), for example of aluminum, which may have a thickness of a few tenths of a nanometer to 1 nm. This metal coating may be obtained by gas-phase deposition. It makes it possible to reduce heat transfers from one layer to another via infrared radiation.

The heat-insulating layers 11 are arranged in the stack so as to reduce heat transfer by conduction from one layer to another. For example, the layers 11 may be separated from each other by a separator 12 interposed between two consecutive layers 11 and glued to them. The separator may for example be in the form of a honeycomb mesh.

The blanket 1 may also comprise an internal layer 13, intended to be exposed between the wall of the spacecraft and the stack 10. This internal layer may be formed, in a manner known to those skilled in the art, of polyimide or Kapton, or of a PET film known by the trade name of Mylar or Dacron.

The blanket 1 further comprises an external layer 20, superimposed on the stack 10, for example glued to one of the heat-insulating layers 11 at the end of the stack 10. This external layer 20 is intended to be exposed to space when the blanket is installed on a wall of a spacecraft, meaning that the stack 10 of heat-insulating layers 11 is then placed between the external layer 20 and the wall of the spacecraft on which the blanket 1 is fixed.

The external layer 20 comprises a second surface mirror or SSM film. Such a film is formed of a metal mirror layer 211, typically of silver or inconel, placed under a layer 210 of fluorinated ethylene propylene FEP or Teflon-FEP, this layer being transparent, so that incident light rays on the SSM film pass through the Teflon-FEP layer and are reflected on the mirror layer 211, which is therefore the second surface encountered by the light rays.

The SSM film may have a thickness of about 100 to 150 µm, for example between 120 and 130 µm. The layer 210 of fluorinated ethylene propylene (FEP) has a thickness that is preferably greater than or equal to 50 µm, for example greater than or equal to 100 µm, for example between 100 and 130 µm. The metal mirror layer has a thickness of about 1.5 µm.

SSM films are traditionally used in spacecraft radiators because the Teflon-FEP layer has good emissivity in the infrared, allowing it to convey heat away from a spacecraft.

However, SSM film also has attractive properties for use as an external layer for thermal protection blankets, because it reflects UV rays, which allows reducing the heat it absorbs when exposed to the sun. In addition, the presence of fluorinated ethylene propylene FEP on the mirror layer ensures good resistance to atomic oxygen. The thickness of the layer to be used depends on the atomic oxygen fluence encountered by the satellite during its mission.

In addition, the external layer 20 comprises a Kapton or polyimide layer 22, joined to the SSM film, and more precisely to the metal mirror layer 211, on the side of this layer that is opposite to the Teflon-FEP layer. For example, the polyimide layer 22 can be adhered to the mirror layer 210. Layer 22 can have a thickness of between 25 and 100 µm, for example around 50 µm. The Kapton layer 22 allows easier manipulation of a blanket provided with such an external layer, and attachment to satellite walls according to conventional methods, which would not be possible without Kapton due to the presence of Teflon-FEP in the SSM film 21. In particular, the Kapton layer makes it possible to assemble a blanket to a spacecraft by riveting the blanket to the wall, and by adhering adjacent blankets to each other by means of adhesive tape, possibly double-sided, affixed to the Kapton layer of each blanket. For this purpose, the external layer 20 of a blanket can be folded up to give access to the Kapton layer 22.

In addition, the presence of a polyimide or Kapton layer 22 makes it possible to use two different configurations for the heat-insulating blanket 1.

A first configuration is shown in FIG. 1a. In this configuration, the external layer 20 is arranged so that the external surface of the blanket is formed by the SSM film, and more particularly by the Teflon-FEP layer 210 of this film. The Kapton layer 22 supporting the SSM film is therefore located on the side that is towards the stack 10 of heat-insulating layers, being between this stack 10 and the SSM film.

In this configuration, the blanket 1 benefits from the thermal properties of the SSM film and in particular from the reflective character of the SSM film which makes it possible to reflect UV rays and to keep the surface of the blanket cold, i.e. not exceeding 10° C., when exposed to the sun. In addition, the Teflon in the SSM film provides protection against atomic oxygen.

On the other hand, this configuration can present disadvantages on certain locations of a spacecraft due to the specular reflections that the SSM film may generate. Indeed, if a spacecraft is completely covered with the blanket 1 in this configuration, depending on the geometry of the craft there may be a risk that certain surfaces of the spacecraft receive solar flux twice: flux coming directly from the sun, and flux reflected from the SSM film of the blanket 1 onto another surface of the spacecraft.

The second configuration, shown in FIG. 1b, is advantageous for overcoming this disadvantage. In this configuration, the external layer 20 is arranged so that the external surface of the blanket is formed by the Kapton layer 22. The SSM film is therefore located on the side that is towards the stack 10 of heat-insulating layers, i.e. between the stack 10 and the Kapton layer 22. The securing of the external layer to the stack 10 may be done on the one hand using peripheral edge treatment, by folding back the edge of the external layer and assembling it to the stack by an adhesive strip, possibly double-sided. On the other hand, such securing is also carried out by anchoring the blanket to the satellite by means of rivets passing through the blanket and distributed regularly along the edge of the blanket.

In this configuration, the blanket stack 10 also benefits from the protection against atmospheric oxygen provided by the Teflon of the SSM film 21. In addition, it is the Kapton layer 22 which forms the external surface of the blanket, facing towards space, and therefore the risk of specular reflection on this external surface is avoided. On the other hand, this configuration tends to heat up more when exposed to the sun than the first configuration, and may reach a temperature of around 120° C.

Therefore, it is advantageous to design the thermal protection of a spacecraft while taking into account its geometry and its intended operational position, in order to determine the walls of the spacecraft that should not create specular reflection. Thermal protection of the spacecraft can then be ensured by covering these walls with the blanket 1 in the second configuration described above where the external surface of the blanket is formed of the Kapton layer 22. As for the other walls, they are covered with the blanket 1 in the first configuration described above where the external surface of the blanket is formed of SSM film 21. Referring to FIG. 3, an example of a satellite 3 is represented in which some walls 30 are covered with a blanket 1 in its first configuration, and other walls 31 are covered with a blanket 1 in its second configuration.

In FIG. 4, a photograph also shows two adjacent walls of a spacecraft, the left wall 30 being covered with a blanket in its second configuration, the dark appearance of the mat corresponding to that of polyimide or Kapton, and the right wall 31 being covered with a blanket in its first configuration, its mirror-like appearance being linked to the SSM film.

Regardless of the configuration adopted, with reference to FIG. 2 which schematically represents an external layer 20 of a blanket viewed from the Kapton layer 22 side, the external layer 20 may comprise areas 23 devoid of Kapton, i.e. cutouts made in the Kapton layer 22. For example, the areas 23 devoid of Kapton may comprise one or more parallel strips placed on at least one edge, for example on two opposite edges of the blanket, and one or more parallel strips placed at a distance from the edges of the blanket. These strips allow connecting the metal mirror layer of the SSM film to the ground of the spacecraft on which the blanket is mounted, for example by means of an electric wire, to prevent the metal layer from becoming electrically charged in space due to the spacecraft’s exposure to electromagnetic fields and from causing unwanted electric shocks. Alternatively (not shown), the grounding of the metal mirror layer of the SSM film may be achieved by manually and locally removing portions of the Teflon layer 211 to allow access, at these portions, to the mirror layer. The external layer 20 then comprises areas (not shown) devoid of Teflon. The blanket also comprises through-holes in its surface (schematically represented by dotted lines 24 in FIGS. 1a and 1b), allowing the discharge of air which may be contained between two heat-insulating layers 11 of the stack 10 during launch of the spacecraft carrying the blanket 1.

It should be noted that Kapton and Teflon-FEP have different coefficients of thermal expansion and their use in an external layer of thermal protection blankets may require adjustments to compensate for these differences. In particular, a person skilled in the art can increase the density of the rivets used, compared to blankets of the state of the art, for attaching the blanket to a satellite wall, in particular at the edges of the blanket, in order to reduce deformations induced on the blanket by these different coefficients of thermal expansion. Holes provided in the blanket for fixing the rivets may also be enlarged to ensure clearance to compensate for deformations.

1. A heat-insulating multi-layer blanket for spacecraft, comprising:
a stack of a plurality of heat-insulating layers, and
an external layer superimposed on the stack, wherein that the external layer includes:
a second surface mirror SSM film, comprising a mirror layer placed under a fluorinated ethylene propylene FEP layer, and
a polyimide layer joined to the SSM film.

2. The heat-insulating blanket according to claim 1, wherein the fluorinated ethylene propylene FEP layer has a thickness greater than 50 µm.

3. The heat-insulating blanket according to claim 1, wherein the polyimide layer is adhered to the mirror layer on the side of the mirror layer that is opposite to the FEP layer.

4. The heat-insulating blanket according to claim 1, wherein the external layer is arranged so that the polyimide layer is located on the side that is towards the stack of heat-insulating layers.

5. The heat-insulating blanket according to claim 1, wherein the external layer is arranged so that the second surface mirror SSM film is located on the side that is towards the stack of heat-insulating layers.

6. The heat-insulating blanket according to claim 1, wherein the mirror layer is made of metal and the external layer comprises at least one area devoid of polyimide in order to allow grounding of the mirror layer.

7. The heat-insulating blanket according to claim 1, wherein the layers of the stack are formed of polyimide comprising a metal coating.

8. A spacecraft comprising thermal protection attached to its walls, wherein that the thermal protection is formed of the heat-insulating blanket according to claim 1.

9. The spacecraft according to claim 8, wherein the thermal protection is formed:
on at least one wall of the spacecraft: of a blanket wherein the external layer is arranged so that the polyimide layer is located on the side that is towards the stack of heat-insulating layers, and such that the second surface mirror SSM layer is the exposed surface of the blanket, and
on at least one other wall of the spacecraft: of a blanket wherein the external layer is arranged so that the second surface mirror SSM film is located on the side that is towards the stack of heat-insulating layers, and such that the polyimide layer is the exposed surface of the blanket.

10. A method for the thermal protection of a spacecraft comprising a set of external walls to be covered with a heat-insulating blanket, the method comprising:
the determination, according to a geometry and an operational position anticipated for the spacecraft, of external walls of the spacecraft that should not produce specular reflection,
the covering of said external walls with a blanket wherein the external layer is arranged so that the second surface mirror SSM film is located on the side that is towards the stack of heat-insulating layers,such that the polyimide layer is the exposed surface of the blanket for these walls, and
the covering of the other walls with a blanket wherein the external layer is arranged so that the polyimide layer is located on the side that is towards the stack of heat-insulating layers, such that the second surface mirror SSM layer is the exposed surface of the blanket for these walls.

11. Use of a second surface mirror SSM film joined to a polyimide layer to create an external layer of a heat-insulating multi-layer blanket according to claim 1.
